(19) United States
(12) Patent Application Publication
(10) Pub. No.: US 2005/0223476 A1
(43) Pub. Date: Oct. 13, 2005

(54) Self-warming and self-cooling clothing

(76) Inventor: Benedikt Volk, Berlin (DE)

Correspondence Address: HOVEY WILLIAMS LLP, 2405 GRAND BLVD., SUITE 400, KANSAS CITY, MO, 64108, US

(21) Appl. No.: 11/096,966

(22) Filed: Apr. 1, 2005

(30) Foreign Application Priority Data
Apr. 8, 2004 (DE) 102004016855.5

(51) Int. Cl. A41B 9/02; A62D 5/00; A62B 17/00

(52) U.S. Cl. 2/458

(57) ABSTRACT

Articles of clothing are disclosed that comprise a water impermeable envelope defining an outer surface and an inner surface and a space between the outer surface and inner surface. The space between the inner and outer surfaces is substantially filled with a gelatinous heat and/or cold thermal storage medium that is fluid at service temperature.

### RELATED APPLICATIONS

This Application claims priority to German Application No. 102004016855.5, filed Apr. 6, 2004, the entire disclosure of which is hereby incorporated by reference.

### BACKGROUND OF THE INVENTION

1. Field of the Invention

The present invention relates generally to items of clothing that are either self-warming, self-cooling or both.

2. Description of the Related Art

Known are only the cooling or warming cushions for tempering the temperature of small body areas for medical purposes, e.g. sport injuries.

Clothing which dissipates cold independently is not known. Only body bandages and the so-called cold cushions for sport injuries, etc. which apply the therapeutic effects of cold temperatures are known.

Conventional clothing can only make use of the body temperature. It can either function in an insulating capacity or it can be used to ensure that the body loses heat rapidly. It cannot increase the energy requirements of the body and cannot in itself warm the body.

Conventional clothing cannot suggest to the body that it is in a different climate by the temperature it dissipates. The problem to be solved by this invention was the production of a jacket, trousers, pullover, vest, coat (with or without hood), shoes and men's or women's briefs which can either dissipate warmth or cold to the body and in so doing either increase the energy consumption of the body or warm the whole body or individual body parts of the body.

Therefore, there is an unmet need for self-cooling clothing that increases the energy consumption of the body permitting faster weight loss. Moreover, there is also a need for self-warming clothing that permits sojournment in cooler temperatures without the body needing to use its own energy to produce warmth. Until now, clothing has merely been designed to prevent the body losing its own warmth.

### SUMMARY OF THE INVENTION

The invention concerns items of clothing made from a water impermeable envelope filled with a medium which is able to store either heat or cold and release this to the body on use of the clothing. The invention provides a practical method of controlling body temperature independently of the external temperature or the body's own temperature. Articles of clothing are provided that comprise a water impermeable envelope defining an outer surface and an inner surface and a space between the outer surface and inner surface. The space between the inner and outer surfaces is substantially filled with a gelatinous heat and/or cold thermal storage medium that is fluid at service temperature.

### BRIEF DESCRIPTION OF THE DRAWING FIGURES

A preferred embodiment of the present invention is described in detail below with reference to the attached drawing figures, wherein:

FIG. 1 illustrates a cross section of a portion of a water-impermeable envelope of a clothing item consistent with the present invention;

FIG. 2 illustrates a section of a portion of a ridge between plastic layers or a heat seal between panels of articles of clothing consistent with the present invention;

FIG. 3 illustrates various embodiments of panels of articles of clothing consistent with the present invention;

FIG. 4 illustrates an outer surface of a panel consistent with the present invention including an aluminum crepe outer surface;

FIG. 5 illustrates a flexible or stretch material between two panels of an article of clothing consistent with the present invention;

FIG. 6 illustrates a panel of an article of clothing consistent with the present invention having a flexible or stretch material between ridges that are between plastic layers associated with the panel; and

FIG. 7 illustrates a two panels of an article of clothing consistent with the present invention, one with velcro for attaching to a second panel, and the other with snaps for attaching to a second panel.

### DETAILED DESCRIPTION OF THE PREFERRED EMBODIMENT

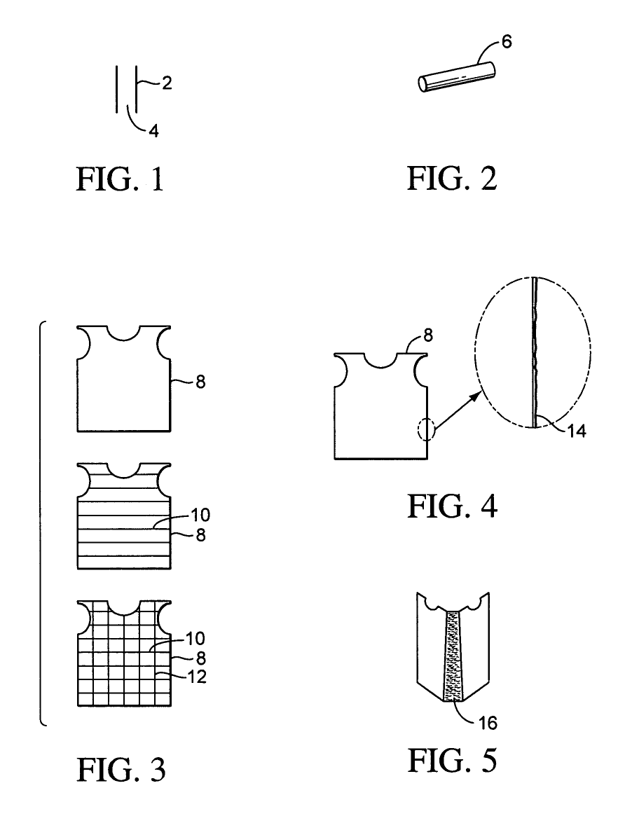

Referring initially to FIG. 1, the invention concerns items of clothing, e.g. a jacket, trousers, pullover, vest, coat (with or without hood), shoes and men's or women's briefs made from a water impermeable envelope 2 filled with a gelatinous heat and/or cold thermal storage medium 4 which is fluid at service temperature. When the human body is exposed to cold, its energy or calorie consumption increases. The reason for this is that the body attempts to maintain a normal temperature of approx. 36.5 deg. C. The invention can help people who want to accelerate their weight loss by increasing the calories necessarily expended on temperature maintenance while undertaking a sporting activity. The invention's users can cool the clothing in apparatus suitable for this purpose and wear it, e.g. when they train in a fitness studio, thereby losing weight in two respects, firstly by training and secondly by increasing their base energy requirements by wearing the invention.

The human body begins to sweat with physical activity such as sport, or when the external temperature has reached a level where the body uses the cooling effects of evaporation to maintain a normal temperature level. People who do not want to sweat during normal exercising can make as good use of the invention (when cooled prior to exercising) as those who wish to exercise in high temperatures. People in hot, muggy areas who, for example, would like to get away from their air-conditioned hotel in the evening and go for a stroll or visit a nearby restaurant, can maintain a normal body temperature by reducing the invention's temperature to a more pleasant temperature.

If the invention is preparatively “charged” with heat, a large source of warmth can be released to the body from the heat-storing thermal medium. Restaurants, which would like to be able to offer their guests the opportunity to sit outside on beautiful, cool, clear evenings can loan their guests warmth-storing thermal coats allowing them to keep either their whole body or parts of the body warm for long periods of time in the cold. The invention is interesting as a fashion accessory. The invention may be made in transparent plastic (for instance) filled with transparent heat and/or cold thermal storage medium so that the clothes warn under the invention can still be on show in cold temperatures. Items of clothing which dissipate heat independently as individual items are unknown.

Problems inherent in known systems are solved consistent with the present invention by a jacket, trousers, pullover, vest, coat (with or without hood), shoes and men's or women's briefs being made from a water impermeable envelope, e.g. polyurethane or another plastic sheeting material, which in the temperature range −30 degrees Celsius to +100 degrees Celsius is adequately pliable and which is filled with a gelatinous or pliable heat or cold thermal storage medium, fluid at service temperature and which does not solidify at temperatures of less than 0 degrees or lose its plasticity.

In various embodiments, the jacket, trousers, pullover, vest, coat (with or without hood), shoes and men's or women's briefs have two halves, a front and aback, which are sealed together at their edges. Both front and back have cells running horizontally across the body in semi-circles which prevent the thermal material from sagging. Each of the sides is made of two layers of plastic film which have been sealed along their edges. One film has horizontal cells separated by ridges. The cells are formed by extruding the film, i.e. swelling it out or in. The cells are filled with heat and/or cold thermal storage material. The second film is laid flat onto the first and sealed along the ridged area of the cells.

Referring now to FIG. 3, in various embodiments, the jacket, trousers, pullover, vest, coat (with or without hood), shoes, men's and women s briefs are divided into rectangular or square cells 10 by way of ridges 12, such as ridge or heat seal 6 of FIG. 2, to ensure even distribution of the thermal gel. Each of the two sides is made of two layers of plastic film which have been sealed along their edges 8. In various embodiments, one film has horizontal and vertical cells separated by ridges forming a crosshatch pattern of substantially quadrilateral-shaped cells. In various embodiments, the cells are square or rectangular in configuration. The cells are formed by extruding the film, i.e. swelling it out or in. The cells are filled with heat and/or cold thermal storage material. The second film is laid flat onto the first and sealed along the ridged area of the cells.

Referring now to FIG. 4, in various embodiments, the jacket, trousers, pullover, vest, coat (with or without hood), shoes, men's or women s briefs have an external thermal insulating layer of, e.g. aluminum crepe foil 14 or thin foam sheeting which in turn is coated with aluminum crepe or foil type material.

Referring now, to FIG. 5, in various embodiments, a stretch material lining 16 is inserted or sewn between the two adjacent halves of the jacket, trousers, pullover, vest, coat (with or without hood), shoes, men's or women's briefs so that the clothing fits snugly. Such stretch material can comprise an elastic band or any number of flexible, elastic, and/or stretchable materials that are known in the art of clothing manufacture.

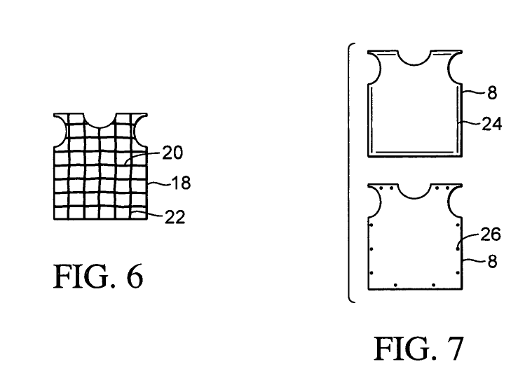

Referring now to FIG. 6, in various embodiments, the jacket, trousers, pullover, vest, coat (with or without hood), shoes, men's or women s briefs have stretch material 22 inserted between the adjacent rectangular or square cells 20 so that the clothing fits snugly.

Referring now to FIG. 7, in various embodiments, the jacket, trousers, pullover, vest, coat (with or without hood), shoes, men's or women s briefs the inner lining of the garment s made of a comfortable material such as cotton (not shown) and may be attached by means of Velcro 24 or snap fasteners 26.

The advantage of the invention is that the jacket, trousers, pullover, vest, coat (with or without hood), shoes, men's or women's briefs can be cooled and influence the body temperature in such a way that the body uses more energy and/or does not begin to sweat. Anyone wishing to lose weight can wear the cooled clothes and burn more calories. People who want to be able to be outside in hot places can avoid sweating; as can people who are exposed to the heat of stage spotlights. The advantage of the invention is that the jacket, trousers, pullover, vest, coat (with or without hood), shoes, men's or women's briefs can be “re-charged” with heat. The body does not then have to compensate for cold temperatures itself, but receives external warmth. This thereby makes it quite possible to rest in one position in cooler temperatures, staying comfortable and warm. It would therefore be possible for cafes, for example, to have the invention available for their guests who would like to sit outside on beautiful but cool spring and autumn days. The invention can also be manufactured as a transparent fashion accessory so that whatever is worm underneath the invention is still visible. The invention could also be used to create a more pleasant feeling for people with poor blood circulation who feel cold.

1. An article of clothing comprising:
a water impermeable envelope defining an outer surface and an inner surface and a space between the outer surface and inner surface, the space substantially filled with a gelatinous heat and/or cold thermal storage medium that is fluid at service temperature.

2. The article of clothing of claim 1, wherein the outer surface defines a Jacket.

3. The article of clothing of claim 1, wherein the outer surface defines trousers.

4. The article of clothing of claim 1, wherein the outer surface defines a pullover.

5. The article of clothing of claim 1, wherein the outer surface defines a vest.

6. The article of clothing of claim 1, wherein the outer surface defines a coat (with or without hood).

7. The article of clothing of claim 1, wherein the outer surface defines a shoe.

8. The article of clothing of claim 1, wherein the outer surface defines men's or women's briefs.

9. The article of clothing of claim 1, wherein the inner and outer surfaces comprise first and second panels, the first and second panels each having edges defining first and second shapes associated with the first and second panels respectively, and the first and second panels being sealed together at their edges, and being sealed interiorly forming cells within the first and second panels, preventing the thermal material from sagging.

10. The article of clothing of claim 9, wherein the first and second sides further comprise first and second layers of plastic film that have been sealed along their edges, the first film having horizontal cells separated by ridges forming a ridged area, the cells being formed by extruding the first layer of film, the cells being filled with the gelatinous heat and/or cold thermal storage medium, and wherein the second layer of plastic film is laid flat onto the first layer of plastic film and sealed along the ridged area of the cells.

11. The article of clothing of claim 9, wherein the first and second sides further comprise first and second layers of plastic film that have been sealed along their edges, the first film having quadrilateral-shaped cells separated by transverse ridges forming a substantially crosshatched ridged area, the cells being formed by extruding the first layer of film, the cells being filled with the gelatinous heat and/or cold thermal storage medium, and wherein the second layer of plastic film is laid flat onto the first layer of plastic film and sealed along the ridged area of the cells.

12. The article of clothing of claim 1, wherein the outer surface is coated with a thermal insulating layer.

13. The article of clothing of claim 12, wherein the thermal insulating layer comprises aluminum crepe foil or thin foam sheeting which in turn is coated with aluminum crepe.

14. The article of clothing of claim 9, further comprising a stretch layer inserted between the first and second panels so that the invention fits the body snugly.

15. The article of clothing of claim 10 further comprising a stretchable material inserted between the quadrilateral shaped cells so that the invention fits the body snugly.

16. The article of clothing of claim 10 further comprising detachable inner lining comprising a material that feels pleasant to the touch.

17. The article of clothing of claim 16 further comprising detachable inner lining comprising a material that feels pleasant to the touch, wherein the material is cotton.

18. The article of clothing of claim 10, wherein the detachable inner lining is attached to the first and second panels with Velcro.

19. The article of clothing of claim 10, wherein the detachable inner lining is attached to the first and second panels with snap fasteners.
